(19) United States
(12) Patent Application Publication
(10) Pub. No.: US 2014/0250311 A1
(43) Pub. Date: Sep. 4, 2014

(54) INFORMATION PROCESSING APPARATUS AND METHOD

(71) Applicant: Toshiba Tec Kabushiki Kaisha, Tokyo (JP)

(72) Inventors: Takahide Kubota, Shizuoka-ken (JP); Shigeki Nimiya, Kanagawa-ken (JP)

(73) Assignee: Toshiba Tec Kabushiki Kaisha, Tokyo (JP)

(21) Appl. No.: 14/194,982

(22) Filed: Mar. 3, 2014

(30) Foreign Application Priority Data
Mar. 4, 2013 (JP) 2013-042189

(51) Int. Cl. G06F 1/26

(52) U.S. Cl. CPC G06F 1/266
USPC 713/310

(57) ABSTRACT

In accordance with one embodiment, an information processing apparatus comprises a connection unit configured to be connectable to a peripheral device, a communication unit configured to be communicable with an external apparatus, a reception unit configured to receive a request from the external apparatus through the communication unit, a first processing unit configured to enable, in a case where the request instructs to carry out a given processing, the peripheral device to execute the processing instructed by the request, and a second processing unit configured to control, in a case where the request instructs to turn on or turn off a specific peripheral device, to turn on or turn off the specific peripheral device in response to the request.

### CROSS-REFERENCE TO RELATED APPLICATION

This application is based upon and claims the benefit of priority from Japanese Patent Application No. 2013-042189, filed Mar. 4, 2013, the entire contents of which are incorporated herein by reference.

### FIELD

Embodiments described herein relate to an information processing apparatus and a method.

### BACKGROUND

Conventionally, in a POS system in a store such as a supermarket and the like, a POS terminal such as a POS register or a personal computer POS is used. A code scanner reading a barcode and the like attached to a commodity, or a card reader reading information from a magnetic card, a printer and the like are connected with the POS terminal as a peripheral device. Further, in recent years, it has been proposed to use a portable information terminal such as a tablet as a cloud POS register.

Further, conventionally, a technology is known such as a WOL (Wake-On-LAN) for turning on or turning off an apparatus such as a PC (Personal Computer) arranged in a remote place through a network.

### BRIEF DESCRIPTION OF THE DRAWINGS

FIG. 1 is a diagram illustrating a constitution of a POS system according to an embodiment;

FIG. 2 is a diagram schematically illustrating one example of the external constitution of an information processing apparatus shown in FIG. 1;

FIG. 3 is a diagram schematically illustrating hardware constitution of the information processing apparatus shown in FIG. 1;

FIG. 4 is a diagram schematically illustrating one example of a state management file shown in FIG. 3;

FIG. 5 is a diagram schematically illustrating a functional component of the information processing apparatus shown in FIG. 1;

FIG. 6 is a diagram illustrating one example of a support screen provided by the information processing apparatus shown in FIG. 1;

FIG. 7 is a diagram illustrating another example of a support screen provided by the information processing apparatus shown in FIG. 1; and

FIG. 8 is a flowchart illustrating one example of a procedure of a request processing carried out by the information processing apparatus shown in FIG. 1.

### DETAILED DESCRIPTION

In accordance with one embodiment, an information processing apparatus comprises a connection unit configured to be connectable to a peripheral device, a communication unit configured to be communicable with an external apparatus, a reception unit, a first processing unit and a second processing unit. The reception unit receives a request from the external apparatus through the communication unit. The first processing unit enables, in a case where the request instructs to carry out a given processing, the peripheral device to execute the processing instructed by the request. The second processing unit controls, in a case where the request instructs to turn on or turn off a specific peripheral device, to turn on or turn off the specific peripheral device in response to the request.

Hereinafter, an embodiment of the information processing apparatus and method is described in detail with reference to accompanying drawings. In addition, the embodiment described below is presented by way of example only, and is not intended to limit the constitution or specification of the information processing apparatus and method. The present embodiment is an application example to a POS system introduced to a store such as a supermarket and the like.

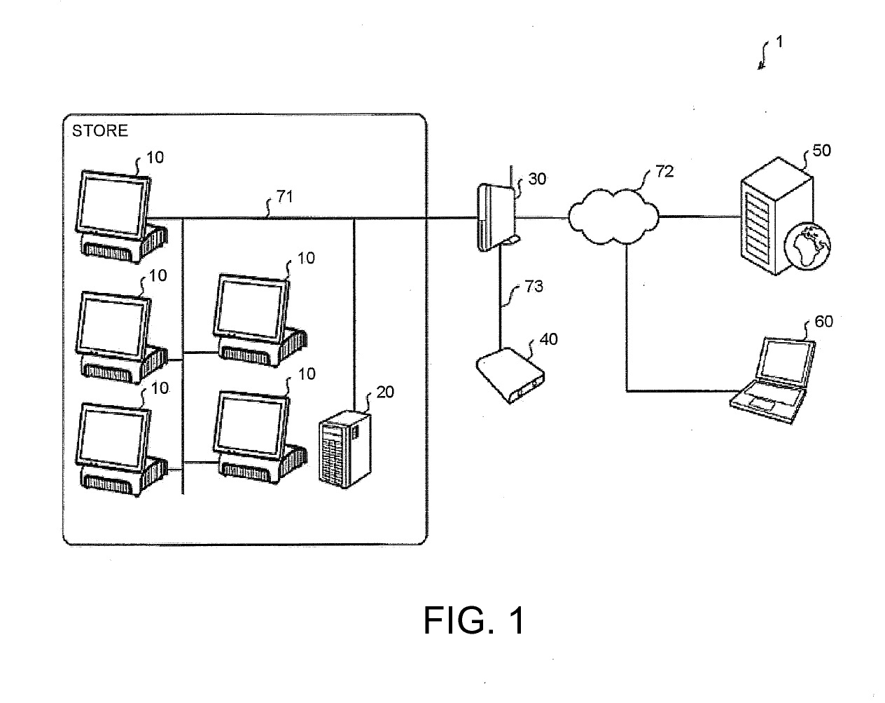

FIG. 1 is a diagram illustrating a constitution of a POS system 1 according to the present embodiment. As shown in FIG. 1, the POS system 1 comprises a POS terminal 10, a store server 20, an information processing apparatus 40, a router 30, a headquarters server 50 and a management PC 60.

The POS terminal 10, the store server 20 and the router 30 are connected with each other through a LAN 71 to be capable of carrying out a communication. Further, the router 30 is connected with the headquarters server 50 and the management PC 60 through a WAN 72 to be capable of carrying out a communication. Further, the information processing apparatus 40 is connected with the POS terminal 10, the store server 20, the headquarters server 50 and the management PC 60 through the router 30 to be capable of carrying out a communication. In addition, the network constitution of the POS system 1 and the number of the POS terminal 10 are not limited to the example shown in FIG. 1.

The POS terminal 10 is a POS terminal such as a POS register or a personal computer POS arranged in a store. The POS terminal 10 registers and settles the commodities involved in one transaction with reference to the commodity master stored by the store server 20. Further, the POS terminal 10 has a power management function of turning on or turning off its own device in response to a control signal (a first control signal and a second control signal) input through the LAN 71.

Herein, the control signal is, for example, a magic packet in a Wake-On-LAN technology. Further, when turned on, the POS terminal 10 can carry out general operation; and when turned off, the POS terminal 10 is in a power saving state in which only part hardware such as a communication interface (not shown) and the like is operating. In addition, the power management function of the POS terminal 10 can be any known technology.

Further, the POS terminal 10 sends various request (hereinafter, referred to as a first request) relating to the use of the peripheral device connected with the information processing apparatus 40 to the information processing apparatus 40. The first request includes, for example, a ‘printing request’ instructing the printing output of a receipt and the like. The first request further includes a ‘code data acquisition request’ instructing to read the code data retained in a code symbol such as a barcode or a two-dimensional code and the like, and a ‘card data acquisition request’ instructing to read the card data recorded in a card such as a magnetic card or an IC card and the like. In addition, it is preferred that the first request is sent using a general protocol such as an HTTP (Hypertext Transfer Protocol) and the like.

The store server 20 is a server apparatus for storing and managing a commodity master in which commodity information (for example, commodity code, unit price and the like) relating to each commodity is stored. The store server 20 collects the data processed by each of the POS terminal 10, and receives various data notified from the headquarters server 50.

The router 30 is a communication apparatus for relaying communication between a plurality of networks. In the present embodiment, the router 30 relays communication between the LAN 71 connected with the POS terminal 10 and the store server 20, the WAN 72 connected with the headquarters server 50 and the management PC 60, and a DMZ (DeMilitarized Zone) 73 connected with the information processing apparatus 40.

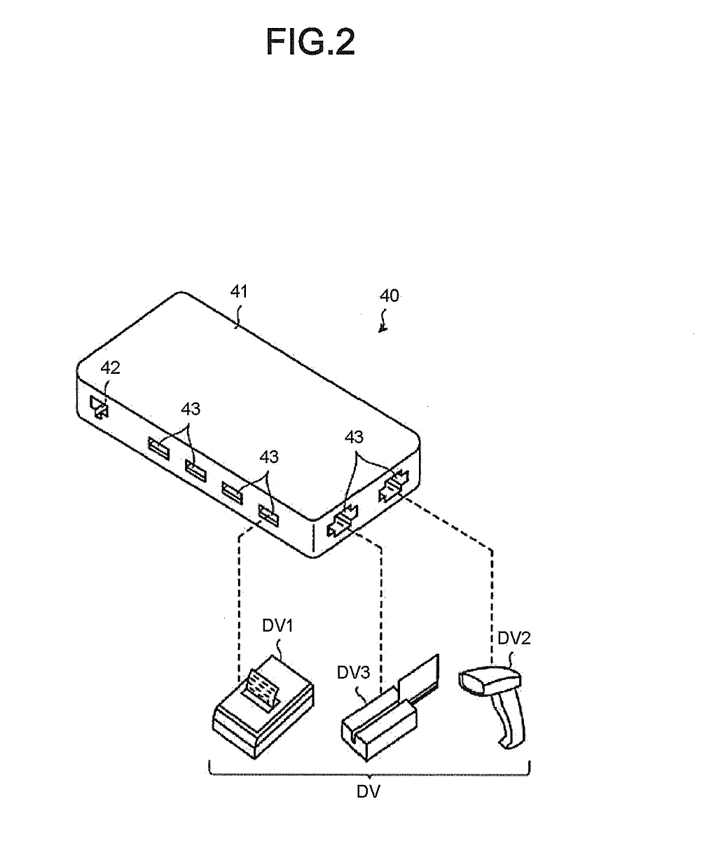

The information processing apparatus 40 is connectable to various peripheral devices. The information processing apparatus 40 has, for example, an external constitution as shown in FIG. 2. Herein, FIG. 2 is a diagram schematically illustrating one example of the external constitution of the information processing apparatus 40. The information processing apparatus 40 has an approximately rectangular parallelepiped shaped thin housing 41. A communication interface 42 communicable with the router 30 is arranged at one side of the housing 41. The communication interface 42 may be an LAN interface and the like. In addition, in a case where a wireless LAN interface (not shown) is arranged inside the housing 41, it can be used to connect with the router 30.

Further, at the side of the housing 41, a plurality of input/output interfaces 43 capable of connecting various devices in a detachable manner are arranged. The input/output interface 43 is, for example, a general input/output interface such as a USE (Universal Serial Bus) or a RS-232C. In the present embodiment, an output device such as a printer DV1 and the like, an input/output device such as a code reader DV2, a card reader DV3 and the like are connected with the input/output interface 43. Hereinafter, these devices are collectively referred to as peripheral device DV. In addition, the peripheral device DV connected with the input/output interface 43 is not limited to the example shown in FIG. 2, and other device such as a display or a keyboard, a mouse, a drawer and the like may also be connected with the input/output interface 43.

The information processing apparatus 40 operates the peripheral device DV connected with the input/output interface 43 in response to the first request sent from the POS terminal 10. Further, the information processing apparatus 40 controls to turn on or turn off a specific POS terminal 10 or a specific peripheral device DV in response to a second request which will be described later and which is sent from the management PC 60. In addition, detailed operations of the information processing apparatus 40 are described later.

The headquarters server 50 is a server apparatus for storing and managing the commodity master (not shown) in which the commodity information of each store is stored. The headquarters server 50 sends the commodity master for each store to the store server 20 of a corresponding store.

The management PC 60 is a terminal apparatus such as a PC or a portable terminal and the like for managing the state of the POS terminal 10 and the information processing apparatus 40. Specifically, the management PC 60 sends various requests (hereinafter referred to as a second request) relating to the state management to the information processing apparatus 40 to turn on or turn off a specific store server 20 or the peripheral device DV.

Herein, the second request may be, for example, a ‘POS management request’ instructing to turn on or turn off the specific store server 20. Further, it may also be a ‘device management request’ instructing to turn on or turn off the specific peripheral device DV connected with the information processing apparatus 40. In addition, it is preferred that the second request is sent using a general protocol such as an HTTP (Hypertext Transfer Protocol) and the like.

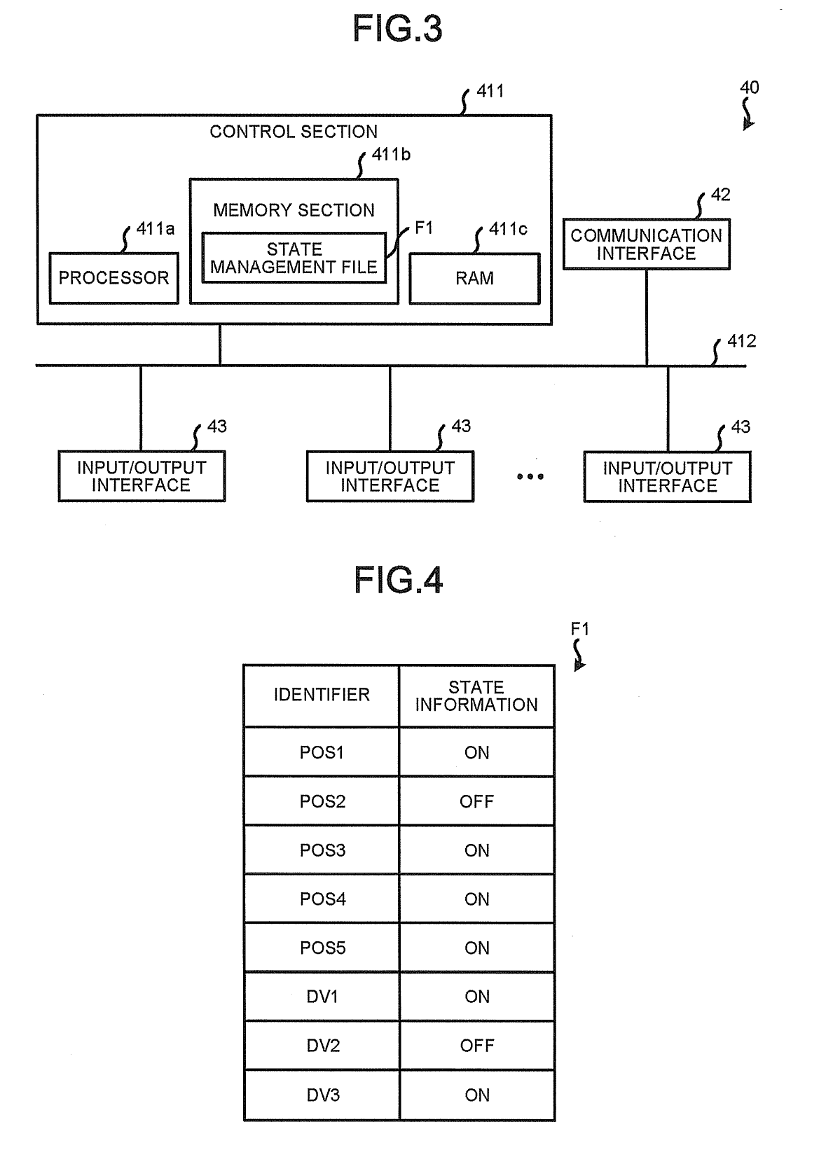

Next, the hardware constitution of the information processing apparatus 40 mentioned above is described. FIG. 3 is a diagram schematically illustrating the hardware constitution of the information processing apparatus 40. As shown in FIG. 3, the information processing apparatus 40 comprises a control section 411 of a computer constitution consisting of a processor 411a such as a CPU (Central Processing Unit) and the like, a memory section 411b, a RAM (Random Access Memory) 411c and the like.

The processor 411a uniformly controls the operations of the information processing apparatus 40 by cooperating with the program stored in the memory section 411b. The memory section 411b is a storage medium such as a ROM, a flash memory, an HDD, an SSD and the like. The RAM 411c functions as a work memory of the processor 411a.

Herein, the memory section 411b stores various programs of an OS or a Web server and the like, various setting information and the like. Further, the memory section 411b stores a profile representing the characteristic of each peripheral device DV connected with the input/output interface 43, and a device driver relating to the operations of the peripheral device DV. Further, the memory section 411b stores a state management file F1 representing the state (turned-on state or turned-off state) of the POS terminal 10 and the peripheral device DV.

FIG. 4 is a diagram schematically illustrating one example of the state management file F1. As shown in FIG. 4, the state management file F1 stores state information representing whether the POS terminal 10 is turned on or turned off in association with an identifier (POS 1˜POS 5) of each POS terminal 10. Further, the state management file F1 stores state information representing whether the peripheral device DV is turned on or turned off in association with an identifier (DV1˜DV3) of each peripheral device DV.

Return to FIG. 3, a communication interface 42 is connected with the control section 411 through a bus line 412. The control section 411 mutually executes online communication with the external apparatus such as the POS terminal 10 and the management PC 60 through the communication interface 42.

Further, a plurality of input/output interfaces 43 mentioned above are connected with the control section 411 through the bus line 412. The control section 411 controls the operations of the peripheral device DV connected with the input/output interface 43 by cooperating with the device driver stored in the memory section 411b.

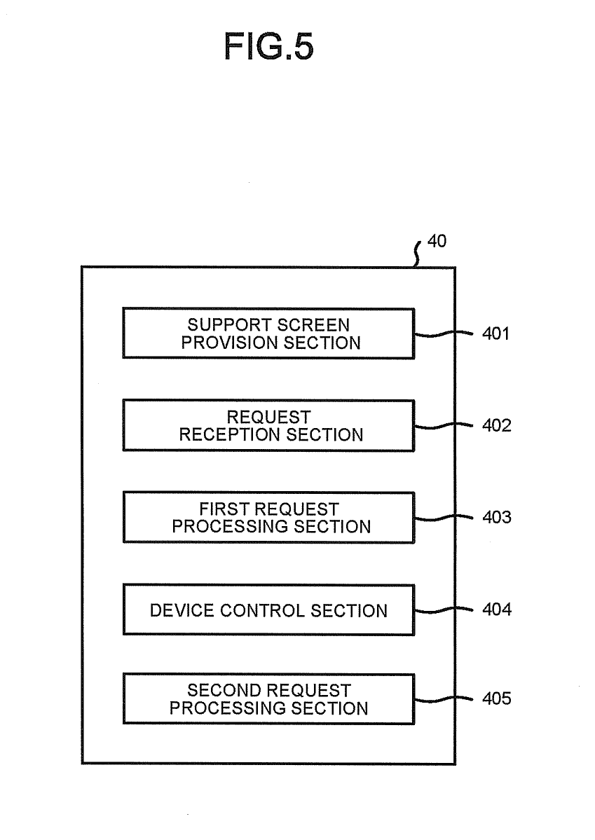

Next, the functional component of the information processing apparatus 40 mentioned above is described. FIG. 5 is a diagram schematically illustrating the functional component of the information processing apparatus 40. The processor 411a of the information processing apparatus 40 realizes, as function sections, a support screen provision section 401, a request reception section 402, a first request processing section 403, a device control section 404 and a second request processing section 405 by reading and executing various programs stored in the memory section 411b. In addition, all or part of these function sections may also be realized by a program such as a web server or a web application and the like.

The support screen provision section 401 provides, for an external apparatus serving as an access source, a support screen for supporting the sending of various requests in response to the access from the external apparatus. For example, the support screen provision section 401 provides the aforementioned support screen as web content in response to the HTTP access from the external apparatus.

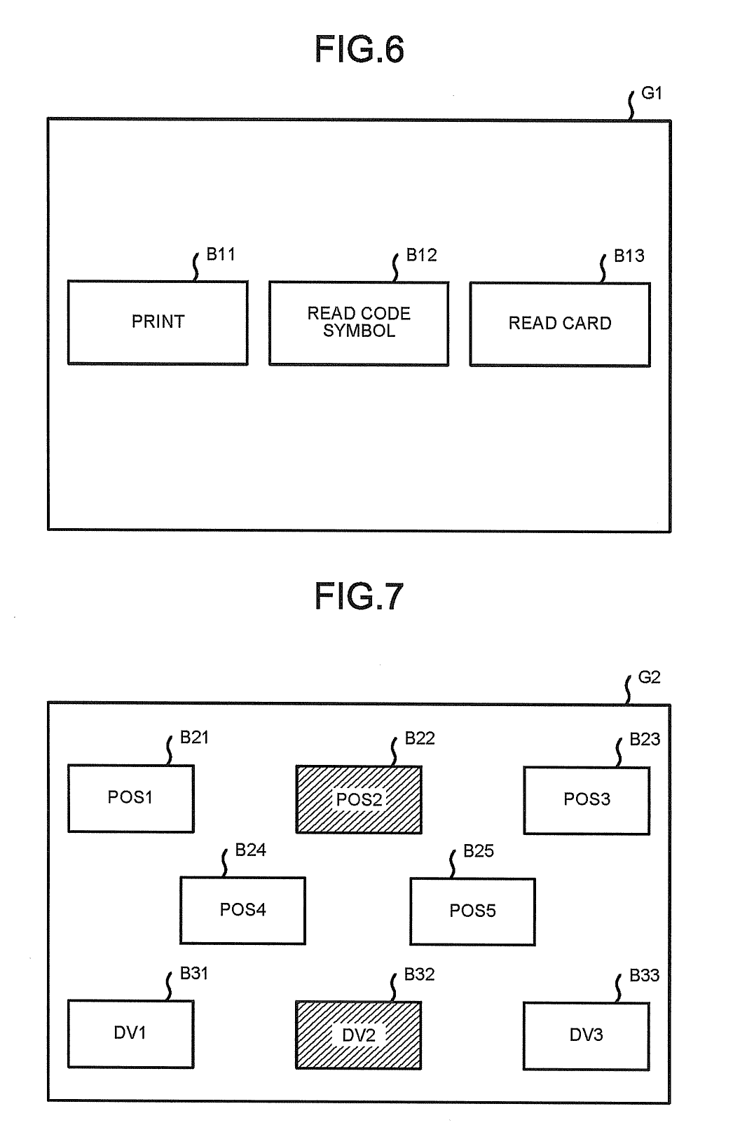

Herein, FIG. 6 is a diagram illustrating one example of the support screen supporting the sending of the first request. A support screen G1 shown in FIG. 6 is, for example, a support screen provided for a POS terminal 10 in response to the access from the POS terminal 10. In this case, the POS terminal 10 displays the provided support screen G1 on a display device (not shown).

In FIG. 6, a button B11 is an operator for sending a printing request. After receiving an operation on the button B11, the POS terminal 10 sends printing data serving as printing target to the information processing apparatus 40 together with the printing request instructing to print the printing data. Herein, the printing data is, for example, the data for outputting a receipt relating to a sales registration of a commodity.

A button B12 is an operator for sending a code data acquisition request. After receiving an operation on the button B12, the POS terminal 10 sends the code data acquisition request instructing to read the code symbol to the information processing apparatus 40. A button B13 is an operator for sending a card data acquisition request. After receiving an operation on the button B13, the POS terminal 10 sends the card data acquisition request instructing to read the card to the information processing apparatus 40.

In addition, the method of sending the first request is not limited to the operation on the buttons B11-B13. For example, in the POS terminal 10, in the process of the operation relating to a commodity settlement, a printing request instructing to output a receipt relating to the settlement may also be sent automatically.

FIG. 7 is a diagram illustrating one example of a support screen supporting the sending of the second request. A support screen G2 shown in FIG. 7 is, for example, a support screen provided for a management PC 60 in response to the access from the management PC 60. In this case, the management PC 60 displays the provided support screen G2 on a display device (not shown).

In FIG. 7, buttons B21˜B25 are operators for sending a POS management request. The buttons B21˜B25 corresponds to each POS terminal 10, and are allotted with an identifier (POS 1˜POS 5) of corresponding POS terminal 10. Further, the buttons B21˜B25 represents whether the corresponding POS terminal 10 is turned on or turned off. In FIG. 7, the POS terminal 10 corresponding to the button B22 with hatching is turned off.

If an operation on any of the buttons B21, B23˜B25 representing a turned-on state is received, the management PC 60 sends a POS management request instructing to turn off the POS terminal 10 corresponding to the operated button to the information processing apparatus 40. Further, if an operation on the button B22 representing a turned-off state is received, the management PC 60 sends a POS management request instructing to turn on the POS terminal 10 corresponding to the operated button to the information processing apparatus 40.

Further, buttons B31˜B33 are operators for sending a device management request. The buttons B31˜B33 corresponds to each peripheral device DV connected with the information processing apparatus 40. An identifier (DV1˜DV3) of corresponding peripheral device DV is allotted to the buttons B31˜B33. Further, the buttons B31˜B33 represents whether the corresponding peripheral device DV is turned on or turned off. In FIG. 7, the code reader DV2 corresponding to the button B32 with hatching is turned off.

If an operation on the buttons B31 and B33 representing a turned-on state is received, the management PC 60 sends a device management request instructing to turn off the peripheral device DV corresponding to the operated button to the information processing apparatus 40. Further, if an operation on the button B32 representing a turned-off state is received, the management PC 60 sends a device management request instructing to turn on the peripheral device DV (code reader DV2) corresponding to the operated button to the information processing apparatus 40.

In addition, the support screen provision section 401 generates buttons B21˜B25 and buttons B31-B33 based on the state information of the POS terminal 10 and the peripheral device DV stored in the state management file F1.

Return to FIG. 5, the request reception section 402 receives various requests sent from the external apparatus such as the POS terminal 10 or the management PC 60 using the communication interface 42.

In a case where the request reception section 402 received the first request, the first request processing section 403 specifies a peripheral device DV (hereinafter, referred to as a corresponding device) corresponding to the processing content instructed by the first request. More specifically, the first request processing section 403 specifies, based on the profile and the like of each peripheral device DV stored in a ROM (not shown), a peripheral device DV capable of executing the processing instructed by the request as the corresponding device.

For example, in a case where the printing request is received, the first request processing section 403 specifies the printer DV1 as the corresponding device. Further, in a case where the code data acquisition request is received, the first request processing section 403 specifies the code reader DV2 as the corresponding device. Further, in a case where the card data acquisition request is received, the first request processing section 403 specifies the card reader DV3 as the corresponding device.

The device control section 404 enables the corresponding device specified by the first request processing section 403 to execute the processing instructed by the first request. More specifically, the device control section 404 cooperates with the device driver and the like of the corresponding device specified by the first request processing section 403 to enable the corresponding device to execute the processing instructed by the first request.

For example, if the printer DV1 is specified as the corresponding device, the device control section 404 enables the printer DV1 connected with the input/output interface 43 to print and output the printing data contained in the printing request. Further, if the code reader DV2 is specified as the corresponding device, the device control section 404 enables the code reader DV2 connected with the input/output interface 43 to read the code data. Further, if the card reader DV3 is specified as the corresponding device, the device control section 404 enables the card reader DV3 connected with the input/output interface 43 to read the card data.

In a case where the request reception section 402 received the second request, the second request processing section 405 controls to turn on or turn off the POS terminal 10 and the peripheral device DV in response to the content instructed by the second request.

Specifically, in a case where the POS management request instructing to turn on a specific POS terminal 10 is received, the second request processing section 405 sends a first control signal instructing to switch to a turned-on state to the specific POS terminal 10. Further, in a case where the POS management request instructing to turn off a specific POS terminal 10 is received, the second request processing section 405 sends a second control signal instructing to switch to a turned-off state to the specific POS terminal 10. Thereby, in the POS terminal 10, if the first control signal or the second control signal sent from the information processing apparatus 40 is received, the state of its own apparatus is switched to a turned-on or turned-off state in response to the control signal.

Further, if the device management request instructing to turn off a specific peripheral device DV is received, the second request processing section 405 turns off the specific peripheral device DV. Further, if the device management request instructing to turn on a specific peripheral device DV is received, the second request processing section 405 turns on the specific peripheral device DV.

Herein, no specific limitation is given to the method of switching the peripheral device DV to a turned-on or turned-off state. For example, the method includes controlling the energization to the peripheral device DV by upping or downing the input/output interface 43 connected with the peripheral device DV. Further, the method also includes turning on or turning off the power source of the peripheral device DV by cooperating with the device driver and the like of the device control section 404 or the peripheral device DV. In addition, in a case where the peripheral device DV to be switched to a turned-off state is executing a processing, the second request processing section 405 waits until the processing is completed, and then switches the peripheral device DV to a turned-off state.

Further, if the second request processing section 405 switches the POS terminal 10 or the peripheral device DV to a turned-on or turned-off state, the state after the switching operation is reflected in the state information of the identifier corresponding to the state management file F1.

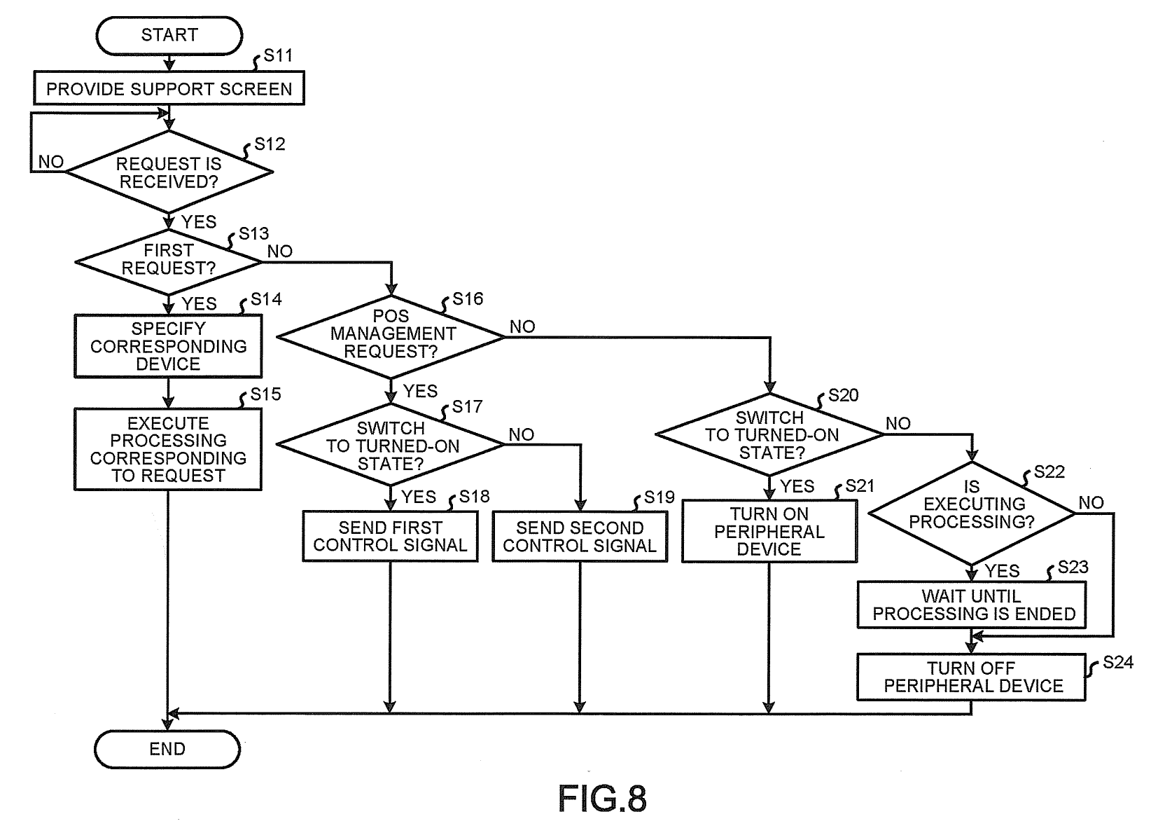

Next, the operations of the information processing apparatus 40 are described. FIG. 8 is a flowchart illustrating one example of a procedure of a request processing carried out by the information processing apparatus 40.

First, the support screen provision section 401 provides, for an external apparatus serving as an access source, a support screen for supporting the sending of various requests in response to the access from the external apparatus (ACT S11). The request reception section 402 waits until a request is sent from the external apparatus based on the provided support screen (NO in ACT S12), and receives, if a request is sent to its own apparatus, the request (YES in ACT S12).

If the request received in ACT S12 is the first request (YES in ACT S13), the first request processing section 403 specifies a corresponding device capable of executing the instructed processing (ACT S14). Then, the device control section 404 enables the corresponding device specified in ACT S14 to execute the processing instructed by the first request (ACT S15), and then the present processing is ended.

On the other hand, if the request received in ACT S12 is the second request (NO in ACT S13), the second request processing section 405 determines whether the second management request is the POS management request or the device management request (ACT S16). If it is determined that the second management request is the POS management request (YES in ACT S16), the second request processing section 405 determines whether or not the POS management request is a request instructing to switch to any of the turned-on and turned-off state (ACT S17).

If the POS management request is a request instructing to switch to the turned-on state (YES in ACT S17), the second request processing section 405 sends the first control signal instructing to switch to the turned-on state to the POS terminal 10 instructed by the POS management request (ACT S18), and then the present processing is ended. Further, if the POS management request is a request instructing to switch to the turned-off state (NO in ACT S17), the second request processing section 405 sends the second control signal instructing to switch to the turned-off state to the POS terminal 10 instructed by the POS management request (ACT S19), and then the present processing is ended.

Further, in ACT S16, if it is determined that the second management request is the device management request (NO in ACT S16), the second request processing section 405 determines whether or not the device management request is a request instructing to switch to any of the turned-on and turned-off state (ACT S20).

If the device management request is a request instructing to switch to the turned-on state (YES in ACT S20), the second request processing section 405 turns on the peripheral device DV instructed by the device management request (ACT S21), and then the present processing is ended.

Further, if the device management request is a request instructing to switch to the turned-off state (NO in ACT S20), the second request processing section 405 determines whether or not the peripheral device DV instructed by the device management request is executing a processing (ACT S22). Herein, if it is determined that no processing is being carried out (NO in ACT S22), the second request processing section 405 turns off the peripheral device DV instructed by the device management request (ACT S24), and then the present processing is ended.

On the other hand, if it is determined that a processing is being executed (YES in ACT S22), the second request processing section 405 waits until the processing is ended (ACT S23). Then, the second request processing section 405 turns off the peripheral device DV instructed by the device management request if the processing is ended (ACT S24), then the present processing is ended.

As stated above, the information processing apparatus 40 of the present embodiment executes the processing corresponding to the request sent from the POS terminal 10 using the peripheral device DV connected with its own apparatus. In this way, as the peripheral device DV connected with the information processing apparatus 40 can be shared by a plurality of POS terminals 10, the convenience of the use of the peripheral device DV can be improved. Further, the information processing apparatus 40 of the present embodiment turns on or turns off the specific POS terminal 10 in response to the request sent from the management PC 60, and turns on or turns off the specific peripheral device DV connected with its own apparatus. In this way, as the management of the POS terminal 10 and the peripheral device DV can be carried out from the external apparatus through the information processing apparatus 40, the management can be carried out efficiently, and the convenience of the use of the peripheral device can be improved.

While certain embodiments of the present invention have been described, these embodiments have been presented by way of example only, and are not intended to limit the scope of the invention. Indeed, the novel embodiments described herein may be embodied in a variety of other forms; furthermore, various omissions, substitutions and changes in the form of the embodiments described herein may be made without departing from the spirit of the invention. The accompanying claims and their equivalents are intended to cover such forms or modifications as would fall within the scope and spirit of the invention.

In the embodiment described above, the information processing apparatus 40 controls the turned-on or turned-off state of the POS terminal 10 in response to the second request from the management PC 60, however, the apparatus serving as a control target is not limited to this. For example, the information processing apparatus 40 may also control the turned-on or turned-off state of the store server 20 in response to the second request from the headquarters server 50 or the management PC 60. Further, the information processing apparatus 40 may also control the turned-on or turned-off state of the POS terminal 10 in response to the second request from the store server 20.

In the embodiment described above, the information processing apparatus 40 controls the turned-on or turned-off state of the peripheral device DV in response to the second request from the management PC 60, however, the sending source of the second request is not limited to this. For example, the information processing apparatus 40 may control the turned-on or turned-off state of the peripheral device DV in response to the second request from the POS terminal 10 or the store server 20. Further, the information processing apparatus 40 may also control the turned-on or turned-off state of the peripheral device DV in response to the second request from the headquarters server 50.

The programs executed by the information processing apparatus 40 of the embodiment described above are incorporated in the memory section 411b in advance, however, it is not limited to this, the programs may also be incorporated in a readable/writable nonvolatile storage medium such as an HDD (Hard Disk Drive) or an SSD (Solid State Drive) and the like. Further, the programs executed by the information processing apparatus 40 of the embodiment described above may also be recorded in a computer-readable recording medium such as CD-ROM, flexible disk (FD), CD-R, DVD (Digital Versatile Disk) in the form of installable or executable file.

Further, the programs executed by the information processing apparatus 40 of the embodiment described above may be stored in a computer connected with a network such as Internet, and downloaded via the network. Further, the programs executed by the information processing apparatus 40 of the embodiment described above may also be provided or distributed via a network such as the Internet.

The programs executed by the information processing apparatus 40 of the embodiment described above has a module constitution including each section mentioned above. As practical hardware, a processor reads and executes a program from the ROM mentioned above, thereby, each section mentioned above is loaded to a main storage apparatus, and generated in the main storage apparatus.

What is claimed is:

1. An information processing apparatus, comprising:
a connection unit configured to be connectable to a peripheral device;
a communication unit configured to be communicable with an external apparatus;
a reception unit configured to receive a request from the external apparatus through the communication unit;
a first processing unit configured to enable, in a case where the request instructs to carry out a given processing, the peripheral device to execute the processing instructed by the request; and
a second processing unit configured to control, in a case where the request instructs to turn on or turn off a specific peripheral device, to turn on or turn off the specific peripheral device in response to the request.

2. The information processing apparatus according to claim 1, wherein
the second processing unit waits, in a case where the specific peripheral device is executing a processing, until the processing is completed, and then controls to turn on or turn off the specific peripheral device.

3. The information processing apparatus according to claim 1, wherein
the second processing unit controls, in a case where the request instructs to turn on or turn off other external apparatus different from the external apparatus connected with its own apparatus, to turn on or turn off the other external apparatus in response to the request.

4. The information processing apparatus according to claim 1, further comprising:
a specification unit configured to specify a peripheral device capable of executing the processing instructed by the request from the peripheral devices connected with the connection unit; wherein
the first processing unit enables the peripheral device specified by the specification unit to execute the processing instructed by the request.

5. The information processing apparatus according to claim 1, further comprising:
a provision unit configured to provide, for the external apparatus, a support screen for supporting the sending of the request in response to an access from the external apparatus; wherein
the reception unit receives the request sent from the external apparatus based on the support screen.

6. A method, including:
receiving a request from an external apparatus through a communication unit;
enabling, in a case where the request instructs to carry out a given processing, a peripheral device to execute the processing instructed by the request; and
controlling, in a case where the request instructs to turn on or turn off a specific peripheral device, to turn on or turn off the specific peripheral device in response to the request.
